(19) United States
(12) Patent Application Publication
(10) Pub. No.: US 2022/0317999 A1
(43) Pub. Date: Oct. 6, 2022

(54) COMMUNICATION APPARATUS, SERVER, AND CONTROL METHOD

(71) Applicant: KYOCERA Corporation, Kyoto (JP)

(72) Inventor: Hiromichi NAKAI, Yokohama-shi (JP)

(73) Assignee: KYOCERA Corporation, Kyoto (JP)

(21) Appl. No.: 17/808,393

(22) Filed: Jun. 23, 2022

Related U.S. Application Data
(63) Continuation of application No. PCT/JP2020/046097, filed on Dec. 10, 2020.

(30) Foreign Application Priority Data
Dec. 24, 2019 (JP) 2019-233507

(51) Int. Cl. G06F 8/658; G06F 8/656; G06F 8/61; H04L 67/00

(52) U.S. Cl. CPC G06F 8/658; G06F 8/656; G06F 8/61; H04L 67/34

(57) ABSTRACT

A communication apparatus 100 that performs wireless communication maintains, in an inactive state, a firmware update function of acquiring an update file used for a firmware update of the communication apparatus by accessing a server 300, performs transmission processing of transmitting sensor data obtained by a sensor to the server, and activates the firmware update function based on activation information acquired from the server at the time of the transmission processing.

### RELATED APPLICATIONS

The present application is a continuation based on PCT Application No. PCT/JP2020/046097, filed on Dec. 10, 2020, which claims the benefit of Japanese Patent Application No. 2019-233507 filed on Dec. 24, 2019. The content of which is incorporated by reference herein in their entirety.

### TECHNICAL FIELD

The present disclosure relates to a communication apparatus, a server, and a control method.

### BACKGROUND ART

In recent years, a technology referred to as Firmware Over the Air (FOTA) has been widely used, in which firmware being a control program incorporated in an apparatus is distributed and updated through wireless communication (for example, see Patent Literature 1).

FOTA includes a push-type method in which a difference file (update file) is distributed from a server to an apparatus when there is firmware update and a pull-type method in which an apparatus inquires of a server about presence or absence of firmware update, and then the apparatus acquires a difference file from the server.

Further, as a method in which firmware update is performed using the push type, a firmware update method using a protocol of Lightweight Machine to Machine (LwM2M) formulated in Open Mobile Alliance (OMA) is known.

### CITATION LIST

### Patent Literature

Patent Literature 1: Japanese application publication No. 2018-45406

### SUMMARY OF INVENTION

A communication apparatus according to a first aspect is a communication apparatus that performs wireless communication and includes a communicator that performs transmission processing of transmitting sensor data obtained by a sensor to a server, and a controller including a firmware update function that inquires of the server about an update file used for a firmware update of the communication apparatus to acquire the update file. The controller activates the firmware update function based on activation information acquired from the server via the communicator at time of the transmission processing. The firmware update function is maintained in an inactive state until the firmware update function is activated by the controller.

A server according to a second aspect is a server that performs communication with a communication apparatus and includes a communicator that performs reception processing of receiving, from the communication apparatus, sensor data obtained by the communication apparatus using a sensor, and a controller that notifies, when a firmware update of the communication apparatus is to be performed, the communication apparatus of activation information via the communicator at time of the reception processing. The activation information causes a firmware update function included in the communication apparatus to activate. The firmware update function is a function where the communication apparatus inquires of the server about an update file used for the firmware update to acquire the update file.

A control method according to a third aspect is a control method of controlling a communication apparatus that performs wireless communication, and includes maintaining, in an inactive state, a firmware update function that inquires of a server about an update file used for a firmware update of the communication apparatus to acquire the update file, performing transmission processing of transmitting sensor data obtained by a sensor to the server, and activating the firmware update function based on activation information acquired from the server at time of the transmission processing.

A control method according to a fourth aspect is a control method of controlling a server that performs communication with a communication apparatus, and includes performing reception processing of receiving, from the communication apparatus, sensor data obtained by the communication apparatus using a sensor, and notifying, when a firmware update of the communication apparatus is to be performed, the communication apparatus of activation information at time of the reception processing. The activation information causes a firmware update function included in the communication apparatus to activate. The firmware update function is a function where the communication apparatus inquires of the server about an update file used for the firmware update to acquire the update file.

### BRIEF DESCRIPTION OF DRAWINGS

FIG. 1 is a diagram illustrating a configuration of a communication system according to one embodiment.

FIG. 2 is a diagram illustrating a configuration of a communication apparatus according to one embodiment.

FIG. 3 is a diagram illustrating a configuration of a server according to one embodiment.

FIG. 4 is a diagram illustrating an operation example of a case where a firmware update is not to be performed.

FIG. 5 is a diagram illustrating an operation example of a case where the firmware update is to be performed (No. 1).

FIG. 6 is a diagram illustrating an operation example of a case where the firmware update is to be performed (No. 2).

### DESCRIPTION OF EMBODIMENTS

When an apparatus does not support a push-type firmware update method, a pull-type firmware update method is used. In this case, the following problem arises.

Specifically, in the pull-type firmware update method, the apparatus periodically accesses a server to confirm presence or absence of a firmware update even if there is no data to be uploaded. Accordingly, there is a problem in that power consumption and resource usage related to data communication of the apparatus increase due to such processing of confirming presence or absence of the firmware update.

In view of this, the present disclosure has an object to suppress increase in the power consumption and the resource usage for the firmware update even if a pull-type firmware update method is used.

Embodiments will be described with reference to the drawings. In the following description regarding the drawings, the same or similar parts are denoted by the same or similar reference signs.

### Configuration of Communication System

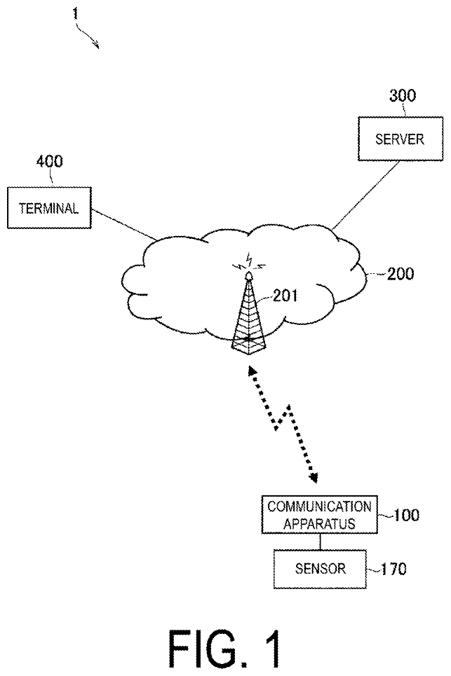

First, a configuration of a communication system according to one embodiment will be described. FIG. 1 is a diagram illustrating a configuration of a communication system 1 according to one embodiment.

As illustrated in FIG. 1, the communication system 1 includes a communication apparatus 100, a network 200, a server 300, and a terminal 400.

The communication apparatus 100 is an apparatus including a communication function, and is, for example, an apparatus used for the application of sensing such as remote monitoring or the like. The communication apparatus 100 has a configuration in which a user can customize a type of sensor used for measurement so that the communication apparatus 100 can support various services related to sensing.

For example, the communication apparatus 100 has a configuration in which a sensor 170 is removable, has high versatility, and can be provided at low costs. Here, “removable” is not limited to a case in which the sensor 170 is physically attachable (mountable) to and removable from the communication apparatus 100, but also includes a case in which the sensor 170 can be electrically connected to and disconnected from the communication apparatus 100 via a cable or the like. Note that the communication apparatus 100 may install the sensor 170 in advance.

The communication apparatus 100 transmits sensor data output by the sensor 170 to the server 300 via wireless communication with a base station 201 included in the network 200. For example, the communication apparatus 100 performs wireless communication of a Low Power Wide Area (LPWA) method. The LPWA method is a method of wireless communication for achieving long-range communication with reduced power consumption. The LPWA method includes, for example, cellular LPWA, Sigfox, or LoRaWAN. The cellular LPWA may include enhanced Machine Type Communications (eMTC) or Narrow Band-Internet of Things (NB-IoT) defined in the 3rd generation partnership project (3GPP) standard.

The network 200 is provided with the base station 201 that performs wireless communication with the communication apparatus 100. The network 200 includes a wide-frequency communication network (Wide Area Network (WAN)). The network 200 may further include the Internet.

The server 300 is connected to the network 200. The server 300 performs communication with the communication apparatus 100 via the network 200. For example, the server 300 performs various configurations with respect to the communication apparatus 100 and collects sensor data from the communication apparatus 100. The server 300 may not be a dedicated server. The server 300 may be a general-purpose terminal in which a predetermined application program is installed or may be a cloud server.

When firmware update of the communication apparatus 100 is to be performed, the server 300 provides, to the communication apparatus 100, a difference file (update file) indicating details of changes with respect to the current firmware of the communication apparatus 100. The difference file (update file) includes a difference program corresponding to a difference of firmware before and after being updated and a version number indicating a version of the firmware after being updated. Note that the server 300 may be physically or logically divided into a server function for collecting the sensor data and a server function for providing the difference file.

As a method of firmware update, a pull-type firmware update method is used. The communication apparatus 100 accesses the server 300, inquires of the server 300 about presence or absence of the firmware update, and then acquires a difference file from the server 300.

The terminal 400 accesses the server 300 via the network 200, receives information from the server 300, and displays the received information. For example, the terminal 400 displays a configuration screen for performing various configurations with respect to the communication apparatus 100 and displays sensor data collected by the server 300 on a remote monitoring screen. The terminal 400 may be a portable terminal, for example, a smartphone, a tablet terminal, a laptop PC, or a wearable terminal. The terminal 400 may be a stationary terminal, for example, a desktop PC.

In the terminal 400, dedicated application software for displaying information received from the server 300 may be installed. In the terminal 400, a general-purpose web browser for displaying information received from the server 300 may be installed.

### Configuration of Communication Apparatus

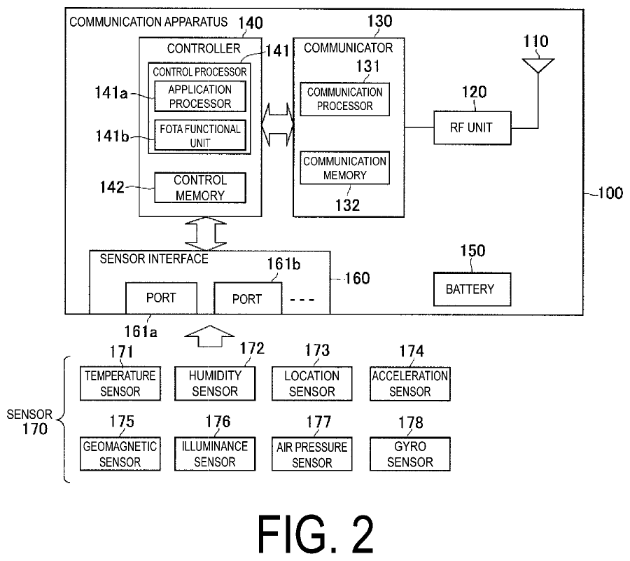

Next, a configuration of the communication apparatus 100 according to one embodiment will be described. FIG. 2 is a diagram illustrating a configuration of the communication apparatus 100 according to one embodiment.

As illustrated in FIG. 2, the communication apparatus 100 includes an antenna 110, a Radio Frequency (RF) unit 120, a communicator 130, a controller 140, a battery 150, and a sensor interface 160.

The antenna 110 and the RF unit 120 transmit and receive a radio signal. Specifically, the RF unit 120 performs amplification processing, filter processing, and the like on a radio signal received by the antenna 110, converts the radio signal into a baseband signal (reception signal), and outputs the resultant signal to the communicator 130. The RF unit 120 converts a baseband signal (transmission signal) output from the communicator 130 into a radio signal, performs amplification processing and the like, and transmits the resultant signal from the antenna 110.

The communicator 130 includes a communication processor 131 that performs communication processing in conformity to the LPWA method. The communication processor 131 may be referred to as a modem or a baseband processor. The communication processing includes processing of layer 1 and layer 2 of an OSI reference model. For example, the communication processor 131 performs demodulation processing, decoding processing, and the like on a reception signal output by the RF unit 120, and outputs reception data to the controller 140. The communication processor 131 performs coding processing, modulation processing, and the like on transmission data output by the controller 140, and outputs a transmission signal to the RF unit 120.

The communicator 130 includes a communication memory 132. The communication memory 132 stores communication firmware executed by the communication processor 131 and is also used as a work area of the communication processor 131. The communication memory 132 includes a non-volatile memory (ROM) that stores the communication firmware and the like, and a volatile memory (RAM) used as the work area.

The controller 140 performs various types of processing and control in the communication apparatus 100. The controller 140 includes a control processor 141. The control processor 141 may be referred to as an application processor. For example, the control processor 141 executes an application, FOTA, a device driver, and each program (firmware) of an operating system (OS). Details of the control processor 141 will be described below.

The controller 140 includes a control memory 142. The control memory 142 stores control firmware executed by the control processor 141 and is also used as a work area of the control processor 141. The control memory 142 includes a non-volatile memory (ROM) that stores the communication firmware and the like, and a volatile memory (RAM) used as the work area.

Note that at least a part of the communication memory 132 and at least a part of the control memory 142 may be physically integrated with each other. For example, the ROM included in the communication memory 132 and the ROM included in the control memory 142 may be physically integrated with each other, or the RAM included in the communication memory 132 and the RAM included in the control memory 142 may be physically integrated with each other.

The battery 150 includes a primary battery or a secondary battery and supplies electrical power for driving the communication apparatus 100.

The sensor interface 160 is an interface to which the sensor 170 is electrically connected. For example, the sensor interface 160 is configured in conformity to one of the Universal Serial Bus (USB) standard, the Universal Asynchronous Receiver/Transmitter (UART) standard, and the Inter-Integrated Circuit (I2C) standard. The sensor interface 160 may be connected to the sensor 170 without using a cable therebetween.

The sensor 170 that may be connected to the sensor interface 160 is, for example, at least one of a temperature sensor 171, a humidity sensor 172, a location sensor 173, an acceleration sensor 174, a geomagnetic sensor 175, an illuminance sensor 176, an air pressure sensor 177, or a gyro sensor 178. The user of the communication apparatus 100 purchases a sensor 170 that meets the needs of the user themselves as necessary and mounts the sensor 170 to the communication apparatus 100. The sensor 170 mounted to the communication apparatus 100 can be removed or replaced by the user. The communication apparatus 100 includes a plurality of ports 161a, 161b, . . . . Individual sensors 170 are electrically connected to respective ports.

Note that the temperature sensor 171 is a sensor that measures temperature and outputs temperature data as sensor data. The humidity sensor 172 is a sensor that measures humidity and outputs humidity data as sensor data. The location sensor 173 is a sensor that measures location and outputs location data as sensor data. For example, the location sensor 173 is configured to include a GNSS receiver. The acceleration sensor 174 is a sensor that measures acceleration and outputs acceleration data as sensor data. The acceleration sensor 174 may be a uni-axial acceleration sensor or may be a multi-axial acceleration sensor. The geomagnetic sensor 175 is a sensor that measures geomagnetic fields and outputs geomagnetic data as sensor data. The illuminance sensor 176 is a sensor that measures illuminance and outputs illuminance data as sensor data. The air pressure sensor 177 is a sensor that measures air pressure and outputs air pressure data as sensor data. The gyro sensor 178 is a sensor that measures angular velocity and outputs angular velocity data as sensor data.

In the communication apparatus 100 configured as described above, the controller 140 controls the communicator 130 so as to perform transmission processing (hereinafter referred to as “data transmission processing”) of transmitting sensor data obtained by the sensor 170 to the server 300. For example, the controller 140 determines whether a preset transmission condition is satisfied. When the transmission condition is satisfied, the communicator 130 performs the data transmission processing. The transmission condition may be a condition that sensor data (sensor value) of a specific sensor 170 exceeds or falls below a threshold. Alternatively, the controller 140 may control the communicator 130 so as to periodically execute the data transmission processing.

The communicator 130 is configured to a power saving mode in a period during which the communicator 130 does not perform the data transmission processing. The power saving mode may be a mode in which power supply to the RF unit 120 and the communicator 130 is stopped. The power saving mode may be Power Saving Mode (PSM) or extended Discontinuous Reception (eDRX) defined in the Third Generation Partnership Project (3GPP) standard.

The control processor 141 of the controller 140 includes an application processor 141a and an FOTA functional unit 141b. The application processor 141a is a functional unit corresponding to an application program being one type of control firmware. The FOTA functional unit 141b is a functional unit corresponding to a firmware update function for performing firmware update using FOTA.

The FOTA functional unit 141b uses the pull-type firmware update method. Specifically, the FOTA functional unit 141b accesses the server 300, inquires of the server 300 about presence or absence of the firmware update, and then acquires a difference file from the server 300. The FOTA functional unit 141b updates firmware to be updated, using the acquired difference file. The firmware to be updated may be control firmware or may be communication firmware.

In a typical pull-type firmware update method, the FOTA functional unit 141b (firmware update function) is constantly maintained in an active state. Thus, the FOTA functional unit 141b (firmware update function) inquires of the server 300 about presence or absence of the firmware update even when the firmware update is not to be performed in actuality. Such constant inquiry causes increase of data traffic and increase of power consumption. Thus, in one embodiment, activation of the FOTA functional unit 141b is enabled only when the firmware update is to be performed.

Specifically, the FOTA functional unit 141b (firmware update function) is maintained in an inactive state until the FOTA functional unit 141b (firmware update function) is activated by the controller 140. The inactive state refers to a state in which operation related to the firmware update is not performed. For example, the FOTA functional unit 141b in the inactive state does not perform operation of inquiring of the server 300 about presence or absence of the firmware update. Thus, while the FOTA functional unit 141b is in the inactive state, increase of power consumption and increase of the resource usage due to operation related to the firmware update do not occur.

At the time of data transmission processing to the server 300, the controller 140 acquires activation information from the server 300 via the communicator 130. Then, the controller 140 activates the FOTA functional unit 141b based on the acquired activation information. Such activation information is hereinafter referred to as “FOTA activation information”. In the active state in which the FOTA functional unit 141b is activated, operation related to the firmware update is performed. After being activated, the FOTA functional unit 141b performs the firmware update by performing operation of inquiring of the server 300 about presence or absence of the firmware update.

In one embodiment, when the controller 140 activates the FOTA functional unit 141b and then the firmware update is completed by the FOTA functional unit 141b, the controller 140 brings the FOTA functional unit 141b back to the inactive state. Accordingly, the FOTA functional unit 141b turns into the active state only when the firmware update is to be performed, and the FOTA functional unit 141b is brought back to the inactive state after the firmware update completes.

In one embodiment, when the controller 140 acquires FOTA activation information indicating activation of the FOTA functional unit 141b from the server 300 at the time of data transmission processing, the controller 140 writes flag information indicating activation of the FOTA functional unit 141b in the control memory 142 (storage) and performs first initialization processing of initializing the controller 140. Initialization of the controller 140 includes at least one of initialization of a volatile memory area of the control memory 142 or initialization of operation of the control processor 141. It is preferable that the flag information is written in a non-volatile memory area of the control memory 142.

After the first initialization processing, the controller 140 activates the FOTA functional unit 141b, in response to the flag information being written in the control memory 142. Subsequently, when firmware update is completed by the FOTA functional unit 141b, the controller 140 deletes the flag information from the control memory 142.

In one embodiment, after the controller 140 performs firmware update with the FOTA functional unit 141b, the controller 140 performs second initialization processing of initializing the controller 140. Then, when the controller 140 normally operates with the updated firmware after the second initialization processing, the controller 140 notifies the server 300 of completion of the firmware update. The update complete notification may include a version number indicating a version of the updated firmware.

Here, as timing of notifying the server 300 of the completion of the firmware update, timing immediately after the firmware update is performed by the FOTA functional unit 141b may be conceivable. However, when the firmware is not correctly updated, the controller 140 may not correctly operate after the second initialization processing. For this reason, the controller 140 notifies the server 300 of the completion of the firmware update at timing after the firmware is updated and the second initialization processing is performed, instead of the timing immediately after the firmware update is performed.

### Configuration of Server

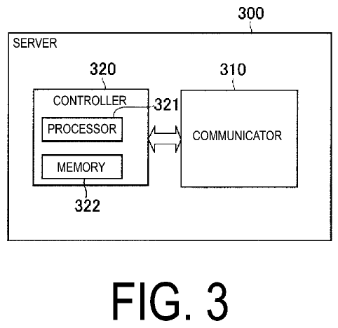

Next, a configuration of the server 300 according to one embodiment will be described. FIG. 3 is a diagram illustrating a configuration of the server 300 according to one embodiment.

As illustrated in FIG. 3, the server 300 includes a communicator 310 and a controller 320. The communicator 310 includes, for example, a wired communication interface. The communicator 310 is connected to the network 200 and performs communication with the communication apparatus 100 via the network 200.

The controller 320 performs various types of processing and control in the server 300. The controller 320 includes a processor 321 and a memory 322. The memory 322 stores a program executed by the processor 321 and is also used as a work area of the processor 321. The memory 322 includes an auxiliary storage device such as an HDD or an SSD.

The controller 320 executes processing of collecting and managing sensor data from the communication apparatus 100 and processing of providing a difference file for updating firmware of the communication apparatus 100 to the communication apparatus 100.

In order to collect sensor data, the communicator 310 performs reception processing (hereinafter referred to as “data reception processing”) of receiving, from the communication apparatus 100, sensor data obtained by the communication apparatus 100 using the sensor 170. The controller 320 stores and manages the sensor data received from the communication apparatus 100.

When firmware update of the communication apparatus 100 is to be performed, the controller 320 notifies the communication apparatus 100 of the FOTA activation information via the communicator 310 at the time of the data reception processing. The FOTA activation information is information for activating the FOTA functional unit 141b included in the communication apparatus 100. The FOTA activation information may be information for indicating or requesting activation of the FOTA functional unit 141b or may be information for giving a notification that the firmware update is to be performed.

After the communication apparatus 100 activates the FOTA functional unit 141b, the communicator 310 receives an inquiry about presence or absence of the firmware update from the communication apparatus 100. The controller 320 notifies the communication apparatus 100 that there is the firmware update (difference file) in response to reception of the inquiry, and distributes the difference file to the communication apparatus 100.

After the communication apparatus 100 completes the firmware update, the communicator 310 receives a completion notification of the firmware update from the communication apparatus 100. The controller 320 determines that the firmware update of the communication apparatus 100 has completed based on the reception of the completion notification. In contrast, when the communicator 310 does not receive the completion notification within a predetermined time period from the distribution of the firmware, the controller 320 may determine that the firmware update of the communication apparatus 100 has failed.

### Operation Example of Communication System

Next, an operation example of the communication system 1 according to one embodiment will be described.

(a) Operation Example of Case where Firmware Update is not to be Performed:

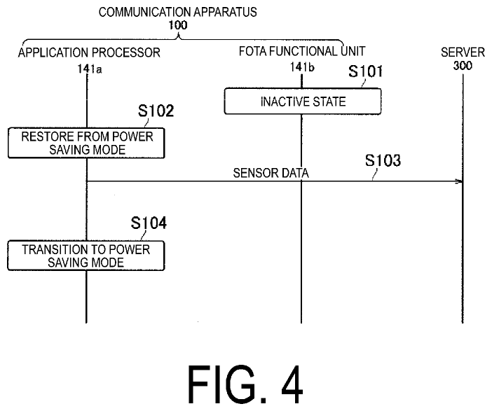

FIG. 4 is a diagram illustrating an operation example of a case where firmware update is not to be performed.

As illustrated in FIG. 4, in Step S101, the controller 140 (FOTA functional unit 141b) of the communication apparatus 100 is in the inactive state.

In Step S102, the controller 140 (application processor 141a) of the communication apparatus 100 determines that the transmission condition of sensor data is satisfied and restores from the power saving mode. The restoration from the power saving mode brings the communicator 130 of the communication apparatus 100 into a state capable of data transmission.

In Step S103, the controller 140 (application processor 141a) of the communication apparatus 100 transmits the sensor data to the server 300 via the communicator 130. The communicator 310 of the server 300 receives the sensor data. Because the controller 320 of the server 300 does not include a difference file to be distributed to the communication apparatus 100, the controller 320 does not notify the communication apparatus 100 of the FOTA activation information.

In Step S104, in response to transmission of the sensor data completes, the controller 140 (application processor 141a) of the communication apparatus 100 transitions to the power saving mode again.

Then, although the operation of Steps S102 to S104 is repeated until the firmware update is to be performed, during which period the FOTA functional unit 141b is maintained in the inactive state.

(b) Operation Example of Case where Firmware Update is to be Performed:

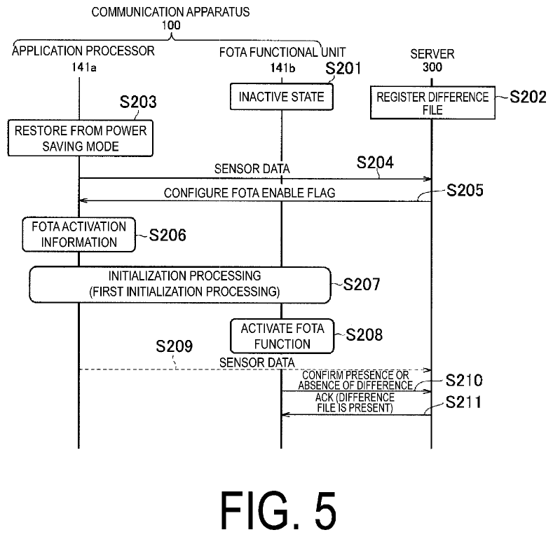

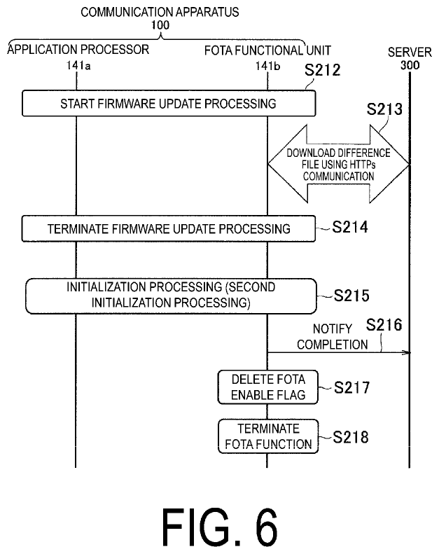

FIG. 5 and FIG. 6 are diagrams illustrating an operation example of a case where the firmware update is to be performed.

As illustrated in FIG. 5, in Step S201, the controller 140 (FOTA functional unit 141b) of the communication apparatus 100 is in the inactive state.

In Step S202, a difference file to be distributed to the communication apparatus 100 is registered with the controller 320 of the server 300.

In Step S203, the controller 140 (application processor 141a) of the communication apparatus 100 determines that the transmission condition of sensor data is satisfied and restores from the power saving mode. The restoration from the power saving mode brings the communicator 130 of the communication apparatus 100 into a state capable of data transmission.

In Step S204, the controller 140 (application processor 141a) of the communication apparatus 100 transmits the sensor data to the server 300 via the communicator 130. The communicator 310 of the server 300 receives the sensor data.

In Step S205, because the controller 320 of the server 300 includes a difference file to be distributed to the communication apparatus 100, the controller 320 notifies the communication apparatus 100 of the FOTA activation information. The communicator 130 of the communication apparatus 100 receives the FOTA activation information. In this case, the controller 140 of the communication apparatus 100 does not transition to the power saving mode even after the transmission of the sensor data completes.

In Step S206, the controller 140 (application processor 141a) of the communication apparatus 100 writes an FOTA enable flag being flag information indicating activation of the FOTA functional unit 141b in the control memory 142. The FOTA enable flag may be a flag of 1 bit of “0” or “1” or may be data of 2 bits or more. The FOTA enable flag may be interpreted as data for enabling FOTA.

In Step S207, the controller 140 of the communication apparatus 100 performs initialization processing (first initialization processing). Note that the processing of Step S207 is not necessarily performed. In a method of related art, after the communication apparatus 100 is turned on, the FOTA functional unit 141b is constantly in the active state. However, in the present embodiment, the FOTA functional unit 141b is basically in the inactive state. When a trigger of activating the FOTA functional unit 141b is the initialization processing, the processing of Step S207 is performed.

In Step S208, after the first initialization processing, the controller 140 (FOTA functional unit 141b) of the communication apparatus 100 checks the FOTA enable flag in the control memory 142 and activates the FOTA functional unit 141b based on the FOTA enable flag being written in the control memory 142.

In Step S209, the controller 140 (application processor 141a) of the communication apparatus 100 transmits the sensor data to the server 300 via the communicator 130. The communicator 310 of the server 300 receives the sensor data. Note that the transmission of the sensor data in Step S209 is not necessarily performed, and the operation may proceed to Step S210 without executing Step S209.

In Step S210, the controller 140 (FOTA functional unit 141b) of the communication apparatus 100 transmits difference presence/absence confirmation information for requesting confirmation of presence or absence of the firmware update (in other words, confirmation of presence or absence of a difference file) to the server 300 via the communicator 130. The communicator 310 of the server 300 receives the difference presence/absence confirmation information.

In Step S211, because the controller 320 of the server 300 includes a difference file to be distributed to the communication apparatus 100, the controller 320 transmits, to the communication apparatus 100, response information (ACK) indicating that there is a difference file to be distributed. The communicator 130 of the communication apparatus 100 receives the response information (ACK).

As illustrated in FIG. 6, in Step S212, the controller 140 (FOTA functional unit 141b) of the communication apparatus 100 starts firmware update processing in response to the reception of the response information (ACK).

In Step S213, the controller 140 (FOTA functional unit 141b) of the communication apparatus 100 downloads the difference file from the server 300 using HTTPs communication via the communicator 130 and updates the firmware using the downloaded difference file. Note that a communication protocol used at the time of downloading the difference file is not limited to HTTPs, and another communication protocol may be used.

In Step S214, the controller 140 (FOTA functional unit 141b) of the communication apparatus 100 terminates the firmware update processing.

In Step S215, the controller 140 of the communication apparatus 100 performs initialization processing (second initialization processing).

In Step S216, after the second initialization processing, the controller 140 (FOTA functional unit 141b) of the communication apparatus 100 confirms that the controller 140 normally operates with the updated firmware and notifies the server 300 of completion of firmware update.

In Step S217, the controller 140 (FOTA functional unit 141b) of the communication apparatus 100 deletes the FOTA enable flag from the control memory 142.

In Step S218, the controller 140 (FOTA functional unit 141b) of the communication apparatus 100 terminates the FOTA function and brings the FOTA function back to the inactive state.

### Gist of Embodiments

As described above, the communication apparatus 100 that performs wireless communication includes the communicator 130 that performs the data transmission processing of transmitting the sensor data obtained by the sensor 170 to the server 300, and the controller 140 including the FOTA functional unit 141b that accesses the update file used for the firmware update of the communication apparatus 100 on the server 300 to acquire the update file. The controller 140 activates the FOTA functional unit 141b based on the FOTA activation information acquired from the server 300 via the communicator 130 at the time of the data transmission processing of the sensor data. The FOTA functional unit 141b is maintained in the inactive state until the FOTA functional unit 141b is activated by the controller 140.

With this configuration, because the communication apparatus 100 can activate the FOTA functional unit 141b only when the firmware update is to be performed, the number of times of performing processing of accessing the server 300 to confirm presence or absence of the firmware update can be minimized. Therefore, increase in the power consumption and the resource usage of the communication apparatus 100 can be suppressed as compared to a case of a method of related art in which the FOTA functional unit 141b is constantly kept activated.

In one embodiment, when the controller 140 activates the FOTA functional unit 141b and then the firmware update is completed by the FOTA functional unit 141b, the controller 140 brings the FOTA functional unit 141b back to the inactive state. With this configuration, increase in the power consumption and the resource usage of the communication apparatus 100 can be suppressed as compared to a case of a method of related art in which the FOTA functional unit 141b is constantly kept activated.

In one embodiment, in response to reception of the FOTA activation information, the controller 140 writes the FOTA enable flag indicating activation of the FOTA functional unit 141b in the control memory 142 and performs the first initialization processing of initializing the controller 140. After the first initialization processing, the controller 140 activates the FOTA functional unit 141b, in response to the FOTA enable flag being written in the control memory 142. With this configuration, only by checking the FOTA enable flag in the control memory 142, the controller 140 can determine whether activation of the FOTA functional unit 141b is to be performed and can appropriately activate the FOTA functional unit 141b.

In one embodiment, when firmware update is completed by the FOTA functional unit 141b, the controller 140 deletes the FOTA enable flag from the control memory 142. With this configuration, unnecessary activation of the FOTA functional unit 141b can be prevented after completion of the firmware update.

In one embodiment, after the controller 140 performs firmware update with the FOTA functional unit 141b, the controller 140 performs the second initialization processing of initializing the controller 140. When the controller 140 confirms that the controller 140 normally operates with the updated firmware after the second initialization processing, the controller 140 notifies the server 300 of completion of the firmware update. With this configuration, because the server 300 can recognize that the firmware has been normally updated, the server 300 can thereafter cause the FOTA functional unit 141b not to activate until the timing of the next firmware update.

### Other Embodiments

There may be provided a program that causes a computer to execute the processing operations performed by the communication apparatus 100 or the server 300. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM, a DVD-ROM, or the like.

The functional units (circuits) for executing the processing operations performed by the communication apparatus 100 may be integrated, and at least a part of the communication apparatus 100 may be configured as a semiconductor integrated circuit (a chipset or an SoC).

Embodiments have been described above in detail with reference to the drawings, but specific configurations are not limited to those described above, and various design modifications can be made without departing from the gist of the present disclosure.

1. A communication apparatus configured to perform wireless communication, the communication apparatus comprising:
a communicator configured to perform transmission processing of transmitting sensor data obtained by a sensor to a server; and
a controller including a firmware update function configured to inquire of the server about an update file used for a firmware update of the communication apparatus to acquire the update file, wherein
the controller is configured to activate the firmware update function based on activation information acquired from the server via the communicator at time of the transmission processing, and
the firmware update function is maintained in an inactive state until the firmware update function is activated by the controller.

2. The communication apparatus according to claim 1, wherein
the controller is configured to bring, when the controller activates the firmware update function and then the firmware update is completed by the firmware update function, the firmware update function back to the inactive state.

3. The communication apparatus according to claim 1, further comprising
a storage, wherein
the controller is configured to
write, when the controller acquires the activation information indicating activation of the firmware update function from the server at time of the transmission processing, flag information indicating the activation of the firmware update function in the storage, and perform first initialization processing of initializing the controller, and
activate, after the first initialization processing, the firmware update function, in response to the flag information being written in the storage.

4. The communication apparatus according to claim 3, wherein
the controller is configured to delete, when the firmware update is completed by the firmware update function, the flag information from the storage.

5. The communication apparatus according to claim 1, wherein
the controller is configured to
perform, after the controller performs the firmware update with the firmware update function, second initialization processing of initializing the controller, and
notify, when the controller normally operates with updated firmware after the second initialization processing, the server of completion of the firmware update.

6. A server configured to perform communication with a communication apparatus, the server comprising:
a communicator configured to perform reception processing of receiving, from the communication apparatus, sensor data obtained by the communication apparatus using a sensor; and
a controller configured to notify, when a firmware update of the communication apparatus is to be performed, the communication apparatus of activation information via the communicator at time of the reception processing, wherein
the activation information is configured to cause a firmware update function included in the communication apparatus to activate, and
the firmware update function is a function where the communication apparatus inquires of the server about an update file used for the firmware update to acquire the update file.

7. A control method of controlling a communication apparatus configured to perform wireless communication, the control method comprising:
maintaining, in an inactive state, a firmware update function configured to inquire of a server about an update file used for a firmware update of the communication apparatus to acquire the update file;
performing transmission processing of transmitting sensor data obtained by a sensor to the server; and
activating the firmware update function based on activation information acquired from the server at time of the transmission processing.

8. A control method of controlling a server configured to perform communication with a communication apparatus, the control method comprising:
performing reception processing of receiving, from the communication apparatus, sensor data obtained by the communication apparatus using a sensor; and
notifying, when a firmware update of the communication apparatus is to be performed, the communication apparatus of activation information at time of the reception processing, wherein
the activation information is configured to cause a firmware update function included in the communication apparatus to activate, and
the firmware update function is a function where the communication apparatus inquires of the server about an update file used for the firmware update to acquire the update file.
